(19) United States
(12) Patent Application Publication
(10) Pub. No.: US 2015/0254764 A1
(43) Pub. Date: Sep. 10, 2015

(54) AUTOMATED AND STANDARDIZED DOCUMENTATION OF DETAILS ASSOCIATED WITH A FRAUD-RELATED FINANCIAL INSTITUTION CALL

(71) Applicant: Bank of America Corporation, Charlotte, NC (US)

(72) Inventors: Alejandro Vasquez Segura, San Jose (CR); Carlos Murillo Williams, San Jose (CR)

(73) Assignee: Bank of America Corporation, Charlotte, NC (US)

(21) Appl. No.: 14/202,845

(22) Filed: Mar. 10, 2014

(51) Int. Cl. G06Q 40/00; G06Q 30/00

(52) U.S. Cl. CPC G06Q 40/00; G06Q 30/01

(57) ABSTRACT

Systems, apparatus, and computer program products are provided for automating and standardizing documentation of details associated with fraud-related financial institution customer calls. Automating the documentation of call details results in a highly efficient process that eliminates the need for the financial institution representatives to manually input notes during or after a call. Standardization of the documentation of details/notes, assures that the notes are accurate and are in a format that can be readily interpreted and used by subsequent financial institution representatives engaged in future calls from the customer or other activities requiring call history information.

### FIELD

In general, embodiments of the invention relate to customer call management and, more particularly, to automating and standardizing documentation of the details associated with a fraud-related financial institution customer call.

### BACKGROUND

Financial institutions that issue credit and debit cards receive a high volume of customer calls associated with fraud-related activity associated with the cards and/or accounts. “Fraud-related” has a broad industry-wide definition that includes not only perceived unauthorized or fraudulent activity but also lost and stolen cards, issues surrounding authentication/verification, declining a card transaction, data being compromised, an online/mobile block or the like.

Currently financial institution representatives, otherwise referred to as associates that handle the fraud-related calls are tasked with manually inputting (i.e., typing) details associated with a call, otherwise referred to as call notes, as a means of documenting the call for future reference. Such manual input of data during the call or immediately after the call is problematic. First off, from the financial institution perspective, manually inputting the details associated with a call is a laborious task that adds to the time required to conduct a call. In addition, manually inputting the details associated with a call results in a wide variance in what information is inputted and thus subsequently accessible to financial institution representatives handling future calls from the customer. Moreover, the associate-to-associate variance in call notes makes it difficult for subsequent financial institution associates to readily find details associated with previous calls, which further exasperates the length of call/inefficiency issue. From the customer perspective, the customer does not desire to participate in a lengthy call and, in this regard, experience delays in the call while the financial institution representative manually inputs call details.

Therefore, a need exists to develop systems, apparatus and the like that automated and standardize documentation of details/notes associated with fraud-related financial institution customer calls. The desired systems, apparatus and the like should be an efficient process that eliminates the need for the financial institution representatives to manually input notes during or after a call, thus decreasing the overall time needed to conduct a call. Moreover, by standardizing the documentation of details/notes, the desired systems, apparatus and the like assures that the notes are accurate and are in a format that can be readily interpreted and used by subsequent financial institution representatives engaged in future calls from the customer or other activities requiring call history information.

### SUMMARY OF THE INVENTION

The following presents a simplified summary of one or more embodiments in order to provide a basic understanding of such embodiments. This summary is not an extensive overview of all contemplated embodiments, and is intended to neither identify key or critical elements of all embodiments, nor delineate the scope of any or all embodiments. Its sole purpose is to present some concepts of one or more embodiments in a simplified form as a prelude to the more detailed description that is presented later.

Embodiments of the present invention address the above needs and/or achieve other advantages by providing apparatus, computer program products or the like for automating and standardizing documentation of details (e.g., notes or the like) associated with fraud-related financial institution customer calls. Automating the documentation of call details results in a highly efficient process that eliminates the need for the financial institution representatives to manually input notes during or after a call. As such, the overall time needed to conduct a call decreases. Standardization of the documentation of details/notes, assures that the notes are accurate and are in a format that can be readily interpreted and used by subsequent financial institution representatives engaged in future calls from the customer or other activities requiring call history information.

An apparatus for automated documentation of details associated with a card fraud-related financial institution customer call defines first embodiments of the invention. The apparatus includes a computing platform including a memory and a processor in communication with the memory. The apparatus further includes a fraud call documentation assistance tool that is stored in the memory and executable by the processor. The tool is configured to display a plurality of user-interfaces that are configured to receive a plurality of user inputs during a financial institution call that has been determined to be fraud-related. The tool is further configured to, as result of the user inputs, generate, display and store, in a standardized format, details associated with the financial institution call. The user inputs and the details include (1) type of caller (2) reason for call, (3) authentication mechanism and criteria, (4) type of call, and (5) actions taken during call.

In specific embodiments of the apparatus, the fraud call documentation assistance tool is further configured to display the plurality of user-interfaces including an authentication user-interface configured to receive user inputs including (1) the type of caller (2) the call reason and (3) an indication that a plurality of preliminary actions have been addressed on the call. In such embodiments of the apparatus, the fraud call documentation assistance tool may be further configured to display the authentication user-interface that is configured to, in response to receiving the user input that indicates that the plurality of preliminary actions have been addressed on the call, display user input fields configured to receive (1) a telephone number confirmation or update and (2) the authentication mechanism and (3) the authentication criteria.

In other specific embodiments of the apparatus, the fraud call documentation assistance tool is further configured to display the plurality of user-interfaces including a call body user-interface that is configured to receive the user input for the type of call and, in response to receiving the user input for the type of call, display a listing of call type-specific actions that are preferred to be taken during the call. Each of the actions has a corresponding user input field configured to receive a user indication that the action has been performed.

In still further specific embodiments of the apparatus, the fraud call documentation assistance tool is further configured to display the plurality of user-interfaces including an account maintenance user-interface configured to receive one or more user inputs that indicate an update to personal profile information associated with the calling customer or an account associated with the calling customer.

In still other specific embodiments of the apparatus, the fraud call documentation assistance tool is further configured to display the plurality of user-interfaces including a script user-interface configured to receive a user input that indicates a type of fraud and, in response to receiving the user input that indicated a type of fraud, display a plurality of scripts associated with the type of fraud that are to communicated to the calling customer. In such embodiments of the apparatus, the fraud call documentation assistance tool is further configured to display the script user-interface configured to receive a user input that acknowledges communication of the scripts to the calling customer, such that, receipt of the user input that acknowledges communication of the scripts provides the user access to a documentation user-interface

Moreover, in other specific embodiments of the apparatus, the fraud call documentation assistance tool is further configured to display the plurality of user-interfaces including a documentation user-interface configured to receive a user input that generates, in a standardized format, documentation for the call based on previous user inputs.

Additionally, in specific embodiments of the apparatus, the fraud call documentation assistance tool is further configured to display the plurality of user-interfaces including a search engine user-interface that is configured to receive user inputs that define search criteria and, as a result of performing a search, display one or more of a service names responsive to the search criteria, and a telephone number associated with the service name.

In additional embodiments of the apparatus, the fraud call documentation assistance tool is further configured to display the plurality of user-interfaces, wherein each user-interface includes (1) a selectable menu of important network links accessible to the user during the call and (2) a timer for timing a length of the call.

A computer program product including a non-transitory computer-readable medium defines second embodiments of the invention. The computer readable medium includes a set of codes for causing a computer to display a plurality of user-interfaces that are configured to receive a plurality of user inputs during a financial institution call that has been determined to be card fraud-related and, as result of the user inputs, generate, display and store, in a standardized format, details associated with the financial institution call. The user inputs and the details include (1) type of caller (2) reason for call, (3) authentication mechanism, and criteria, (4) type of call, and (5) actions taken during call.

Thus, systems, apparatus, methods, and computer program products herein described in detail below provide for automatically determining suspicious activity related to cash balancing transactions conducted by cash drawer users. Cash balancing transaction data is received, via a production feed or the like, that allows for suspicious activity to be determined based on identifying patterns of abnormal behavior in the balancing transaction data. Once suspicious activity has been determined further investigation can incur to determine if the activity is related to force balancing, misappropriation or some other risk related activity. As such the present invention provides for proactive early detection of suspicious activities associated with cash balancing and, as a result, reduces the risk of financial loss imposed on cash drawer owner.

To the accomplishment of the foregoing and related ends, the one or more embodiments comprise the features hereinafter fully described and particularly pointed out in the claims. The following description and the annexed drawings set forth in detail certain illustrative features of the one or more embodiments. These features are indicative, however, of but a few of the various ways in which the principles of various embodiments may be employed, and this description is intended to include all such embodiments and their equivalents.

### BRIEF DESCRIPTION OF THE DRAWINGS

Having thus described embodiments of the invention in general terms, reference will now be made to the accompanying drawings, which are not necessarily drawn to scale, and wherein:

FIG. 1 provides a block diagram of an apparatus configured for automating and standardizing documentation of details associated with fraud-related financial institution customer calls, in accordance with embodiments of the present invention;

FIG. 2 provides a more detailed block diagram of an apparatus configured for automating and standardizing documentation of details associated with fraud-related financial institution customer calls, in accordance with present embodiments of the invention;

FIGS. 3-6 and 8 provides examples of an authentication user-interface within a fraud call documentation assistance tool, in accordance with present embodiments of the invention;

FIG. 7 provides an example of an authentication user-interface and an authentication criteria user-interface within a fraud call documentation assistance tool, in accordance with present embodiments of the invention;

FIGS. 9-11 provide examples of a call body user-interface within a fraud call documentation assistance tool, in accordance with embodiments of the present invention;

FIG. 12 provides an example of an account maintenance user-interface within a fraud call documentation assistance tool, in accordance with embodiments of the present invention;

FIG. 13 provides an example of a script user-interface within a fraud call documentation assistance tool, in accordance with embodiments of the present invention;

FIGS. 14 and 15 provide an example of a documentation user-interface within a fraud call documentation assistance tool, in accordance with embodiments of the present invention;

FIG. 16 provides an example of a search engine user-interface within a fraud call documentation assistance tool, in accordance with embodiments of the present invention; and

FIG. 17 provides an example of an important addresses user-interface within a fraud call documentation assistance tool, in accordance with embodiments of the present invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to like elements throughout. Although some embodiments of the invention described herein are generally described as involving a “financial institution,” one of ordinary skill in the art will appreciate that the invention may be utilized by other businesses that take the place of or work in conjunction with financial institutions to perform one or more of the processes or steps described herein as being performed by a financial institution.

As will be appreciated by one of skill in the art in view of this disclosure, the present invention may be embodied as an apparatus (e.g., a system, computer program product, and/or other device), a method, or a combination of the foregoing. Accordingly, embodiments of the present invention may take the form of an entirely hardware embodiment, an entirely software embodiment (including firmware, resident software, micro-code, etc.), or an embodiment combining software and hardware aspects that may generally be referred to herein as a “system.” Furthermore, embodiments of the present invention may take the form of a computer program product comprising a computer-usable storage medium having computer-usable program code/computer-readable instructions embodied in the medium.

Any suitable computer-usable or computer-readable medium may be utilized. The computer usable or computer readable medium may be, for example but not limited to, an electronic, magnetic, optical, electromagnetic, infrared, or semiconductor system, apparatus, or device. More specific examples (e.g., a non-exhaustive list) of the computer-readable medium would include the following: an electrical connection having one or more wires; a tangible medium such as a portable computer diskette, a hard disk, a time-dependent access memory (RAM), a read-only memory (ROM), an erasable programmable read-only memory (EPROM or Flash memory), a compact disc read-only memory (CD-ROM), or other tangible optical or magnetic storage device.

Computer program code/computer-readable instructions for carrying out operations of embodiments of the present invention may be written in an object oriented, scripted or unscripted programming language such as Java, Perl, Smalltalk, C++ or the like. However, the computer program code/computer-readable instructions for carrying out operations of the invention may also be written in conventional procedural programming languages, such as the “C” programming language or similar programming languages.

Embodiments of the present invention are described below with reference to flowchart illustrations and/or block diagrams of methods or apparatuses (the term “apparatus” including systems and computer program products). It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a particular machine, such that the instructions, which execute by the processor of the computer or other programmable data processing apparatus, create mechanisms for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer readable memory produce an article of manufacture including instructions, which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions, which execute on the computer or other programmable apparatus, provide steps for implementing the functions/acts specified in the flowchart and/or block diagram block or blocks. Alternatively, computer program implemented steps or acts may be combined with operator or human implemented steps or acts in order to carry out an embodiment of the invention.

According to embodiments of the invention described herein, various systems, apparatus, methods, and computer program products are herein described for automating and standardizing documentation of details (e.g., notes or the like) associated with fraud-related financial institution customer calls. Automating the documentation of call details results in a highly efficient process that eliminates the need for the financial institution representatives to manually input notes during or after a call, thereby decreasing the overall time needed to conduct a call. Standardization of the documentation of details/notes, assures that the notes are accurate and are in a format that can be readily interpreted and used by subsequent financial institution representatives engaged in future calls from the customer or other activities requiring call history information.

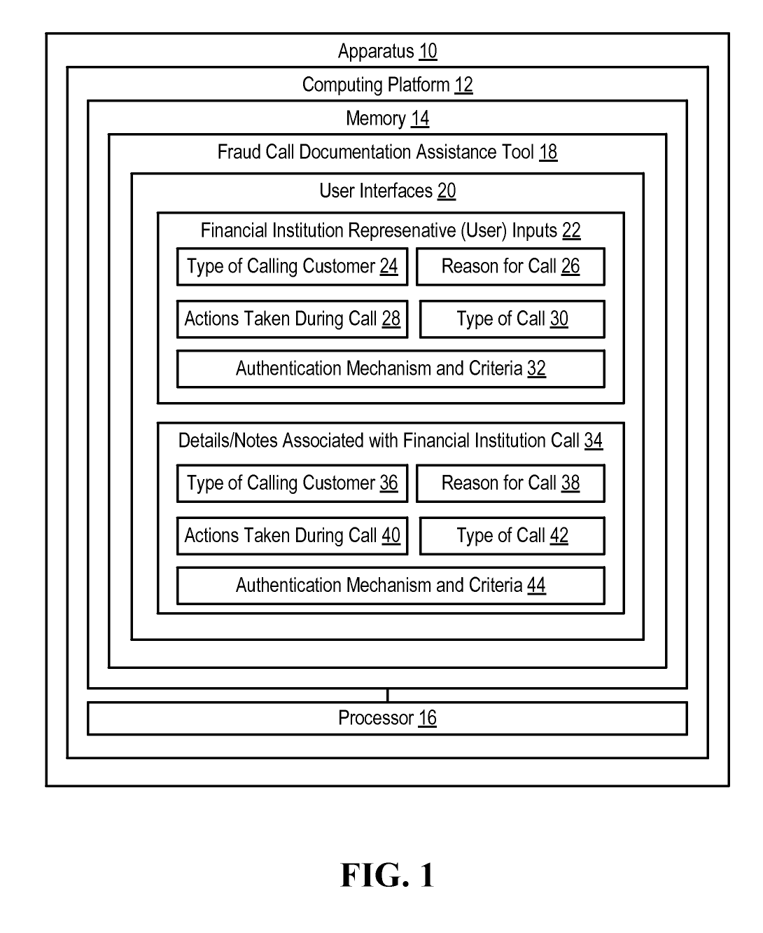

Referring to FIG. 1, a block diagram is presented of an apparatus 10 configured for automating and standardizing documentation of details associated with fraud-related financial institution customer calls, in accordance with embodiments of the present invention. The apparatus includes a computing platform 12 having a memory 14 and at least one processor 16 in communication with the memory 14. The memory 14 of apparatus 10 stores fraud call documentation assistance tool 18 that is configured to automate and standardize documentation of details, otherwise referred to herein as notes, associated with a fraud-related financial institution customer call. It should be noted that the fraud-related financial institution call is typically a telephone call but may also, other embodiments of the invention, include a chat session call (e.g., voice or text) or the like. As previously noted “fraud-related” has a broad industry-wide definition that includes not only perceived unauthorized or fraudulent activity but also lost and stolen cards, issues surrounding authentication/verification, declining a card transaction, data being compromised, an online/mobile block or the like.

The fraud call documentation assistance tool 18 is configured to display a plurality of user-interfaces 20 that are configured to receive a plurality of user inputs 22 from a user/financial institution representative during a financial institution call. The financial institution call is a fraud-related call. The user inputs 22 may include, but are not limited to, the type of caller/customer 24 (i.e., the relationship of the caller to the account or transaction in question), the reason for the call 26, the actions taken during the call 28, the type of call 30 and the authentication mechanism and criteria used to authenticate 32.

As result of the user inputs, the fraud call documentation assistance tool 18 is configured to generate, display and store, in a standardized format, details 34 associated with the financial institution call. The details 34, otherwise referred to as notes, may include, but are not limited to the type of caller 36 (i.e., the relationship of the caller to the account or transaction in question), the reason for the call 38, the actions taken during the call 40, the type of call 42 and the authentication mechanism and criteria used to authenticate 32. The details 34 are compiled in a standardized format such that subsequent users/financial institution representatives may access the details/notes 34 during future calls or the like and are able to readily comprehend the nature and details of the previous call(s) based on the standardized format of the notes. Additionally, since the details/notes capture most, if not all, of the user inputs 22 made by the user/financial institution representative during the call, the details/notes are comprehensive and consistent from call-to-call. Moreover, since the details/notes 34 are generated automatically in response to the user inputs, without requiring the user to manually type out the details/notes and/or recall what transpires on the call, the details/notes are consistent from user-to-user (i.e., each different financial institution representative will automatically generate details/notes 34 that include the same subject matter in the same format.

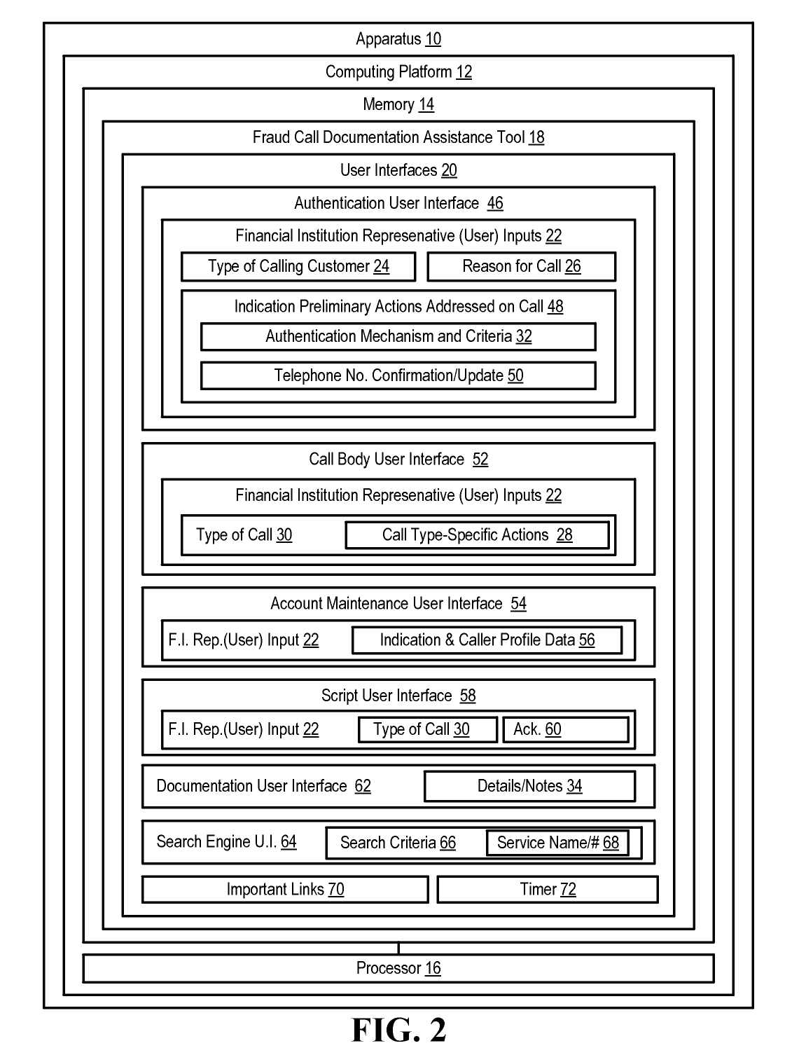

Referring to FIG. 2, a block diagram is presented of an apparatus 10 configured for automating and standardizing documentation of details associated with fraud-related financial institution customer calls, in accordance with embodiments of the present invention. The apparatus 10 may include any type and/or combination of one or more computing devices. The apparatus 10 is operable to receive and execute modules, routines and applications, such as fraud call documentation assistance tool 18 and the like.

The apparatus 10 includes computing platform 12 that can receive and execute routines and applications. Computing platform 12 includes memory 14, which may comprise volatile and nonvolatile memory such as read-only and/or random-access memory (RAM and ROM), EPROM, EEPROM, flash cards, or any memory common to computer platforms. Further, memory 14 may include one or more flash memory cells, or may be any secondary or tertiary storage device, such as magnetic media, optical media, tape, or soft or hard disk.

Further, computing platform 12 also includes at least one processor 16, which may be an application-specific integrated circuit (“ASIC”), or other chipset, processor, logic circuit, or other data processing device. Processor 16 or other processor such as ASIC may execute an application programming interface (“API”) layer (not shown in FIG. 2) that interfaces with any resident programs, such as balancing transaction assessment module 18 or the like, stored in the memory 14 of apparatus 10. Processor 16 includes various processing subsystems (not shown in FIG. 2) embodied in hardware, firmware, software, and combinations thereof, that enable the functionality of apparatus 10 and the operability of the apparatus on a network. For example, processing subsystems allow for initiating and maintaining communications, and exchanging data, with other networked devices. Additionally, processing subsystems may include any portion of the functionality of fraud call documentation assistance tool 18 obviating the need for such applications and modules to be stored in the memory.

As previously noted in relation to FIG. 1, memory 14 stores fraud call documentation assistance tool 18 that is configured for automating and standardizing documentation of details/notes associated with fraud-related financial institution customer calls. As previously discussed, the fraud call documentation assistance tool 18 is configured to display a plurality of user-interfaces 20 that are configured to receive a plurality of user inputs 22 from a user/financial institution representative during a fraud-related financial institution call.

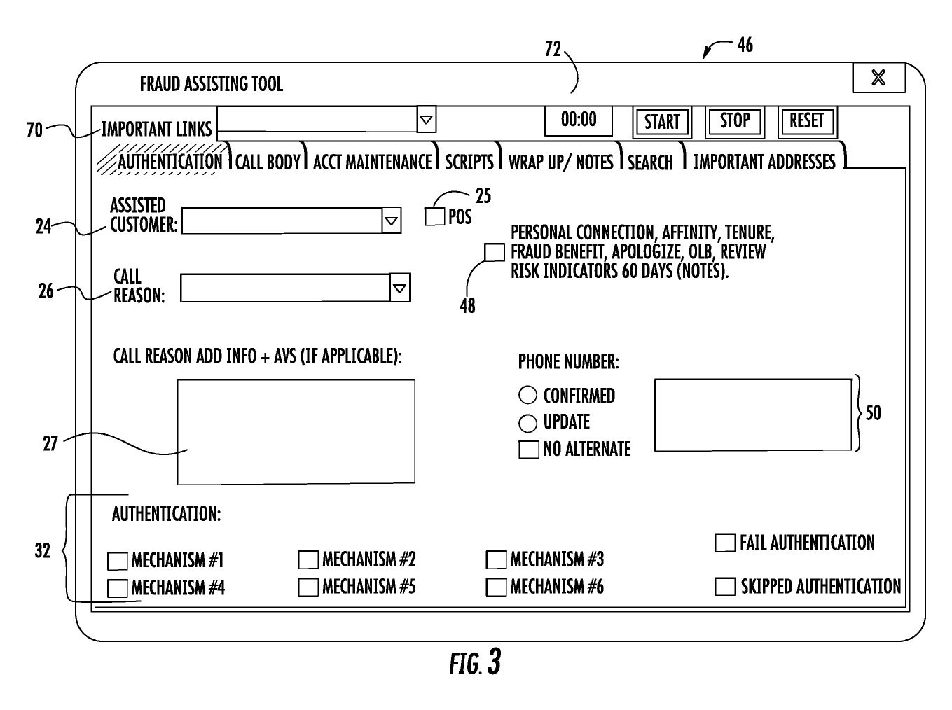

In specific embodiments of the invention the user-interfaces 20 include an authentication user-interface 46. Examples of an authentication user-interface are shown in FIGS. 3-8, and discussed infra. The authentication user-interface 46 is configured to receive user inputs 22 from the user/financial institution representative during the fraud-related call. The user inputs 22 may include, but are not limited to, type of caller 24 (e.g., primary call holder, authorized user, co-signer, bank associate, merchant, third party, possible perpetrator or the like), the reason for the call 26 (e.g., declined card, problem with authentication process, problem at point-of-sale transaction, data compromised, blocked from online/mobile account access, or the like), and an indication that preliminary actions have been addressed (acknowledged or undertaken) during the call 48 (e.g., review of risk indicators, apology to caller, make personalized connection with caller, acknowledge caller's tenure and/or affinities and the like).

In specific embodiments of the invention, the authentication user-interface 46 may be configured such that receipt of a user input that indicates that preliminary actions have been addressed during the call 48. Unlocks or otherwise makes available other user input fields within the user-interface. (e.g., previously “grayed-out” features become available for user input) For example, in specific embodiments of the invention receipt of a user input that indicates that preliminary actions have been addressed during the call 48, allows the user/financial institution representative to make user inputs for the authentication mechanism and authentication criteria used to authenticate the caller 32 and telephone number confirmation/update 50. In many financial institution more than one authentication mechanism may be available to the user, for example, internal systems/mechanisms may be used or external/third party systems may be used. Accordingly, each of the authentication mechanisms may provide for different authentication criteria for authenticating/validating the identity of the caller. For example, authentication criteria may include, but is not limited to, date of birth, social security number, address, mother's maiden name and the like. Additionally, user input fields may be provided for within the authentication user-interface 46 that indicate that the caller failed the authentication process or that the authentication process was omitted. Telephone number confirmation/update 50 insures that the financial institution's contact records are accurate. As such, the telephone number confirmation/update 50 may include, within the authentication user-interface 46, a user input field for entering updated telephone numbers.

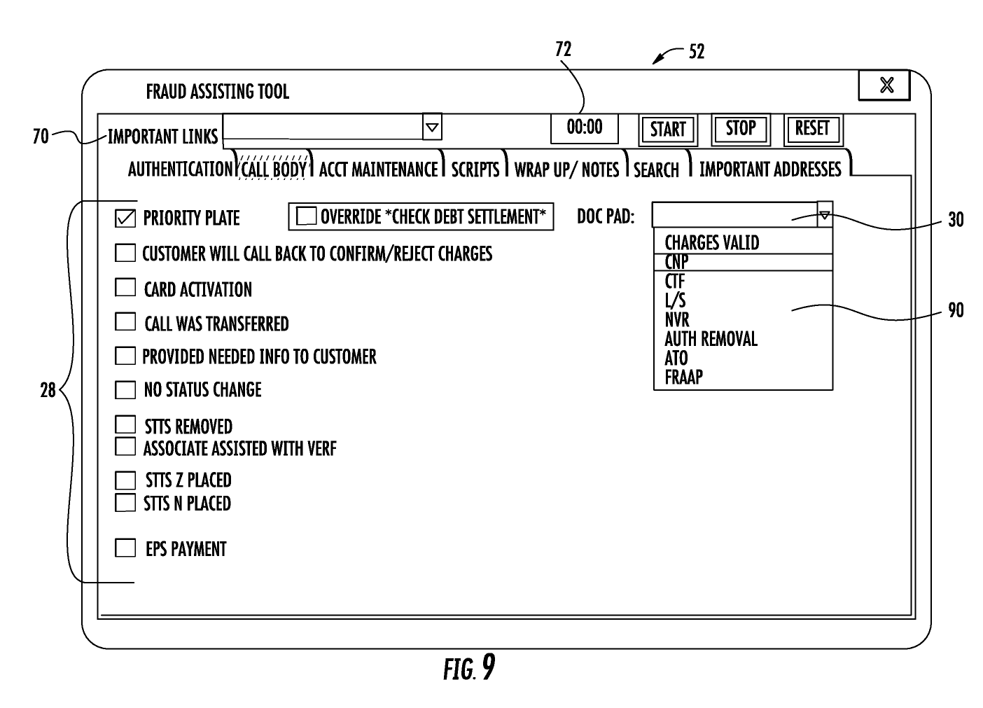

In specific embodiments of the invention the user-interfaces 20 include a call body user-interface 52. Examples of a call body user-interface 52 are shown in FIGS. 9-11, and discussed infra. The call body user-interface 52 is configured to receive user inputs 22 from the user/financial institution representative during the call. The user inputs include the type of call 30 (e.g., charges valid, card-not-present transaction, lost/stolen card, counterfeit, card-not-received, remove authentication or the like) and call type-specific actions 28 addressed during the call (e.g., acknowledged to the caller or undertaken during the call). In specific embodiments of the fraud call documentation assistance tool 18, the call-specific actions 28 required to be taken during the call are displayed in the call body user-interface 52 in response the user selecting the type of call 30.

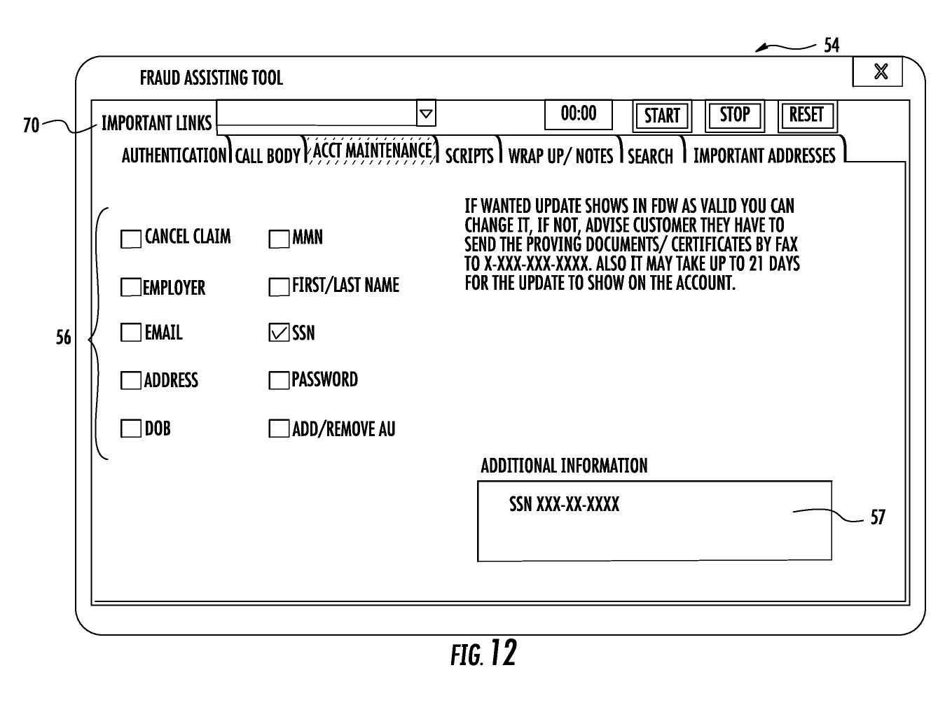

In specific embodiments of the invention the user-interfaces 20 include an account maintenance user-interface 54. An example of an account maintenance user-interface 54 is shown in FIG. 12, and discussed infra. The account maintenance user-interface 52 is configured to receive user inputs 22 that indicates that a maintenance to an identified field in a caller profile 56 is being performed and provides an input field for the user/financial institution representative to input the updated data (e.g., address, employer, email address, password, social security number, name, add/remove authenticated user, date of birth, mother's maiden name and the like).

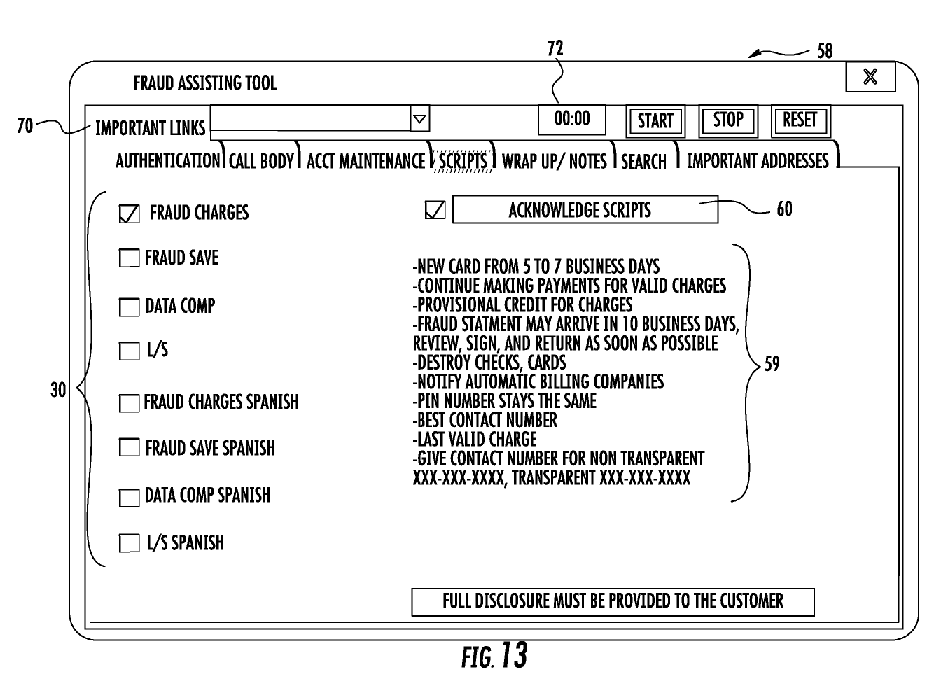

In further specific embodiments of the invention the user-interfaces 20 include a script user-interface 54. An example of a script user-interface 58 is shown in FIG. 13, and discussed infra. The script user-interface 58 is configured to receive user inputs 22 that identify the type of call 30 and in response to indicating the type of call provides display of one or more scripts 59 or information required to be communicated to the caller during the call. In addition, the script user-interface 52 is configured to receive user inputs 22 that acknowledges 60 that the user/financial institution representative has read and communicated the scripts 59 to the caller.

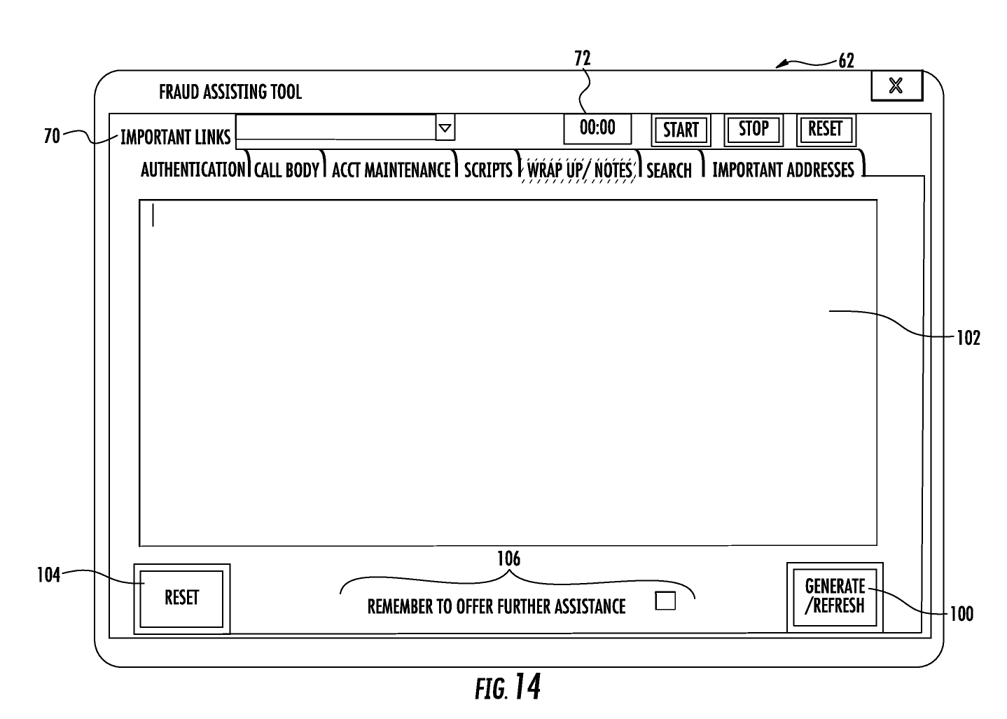

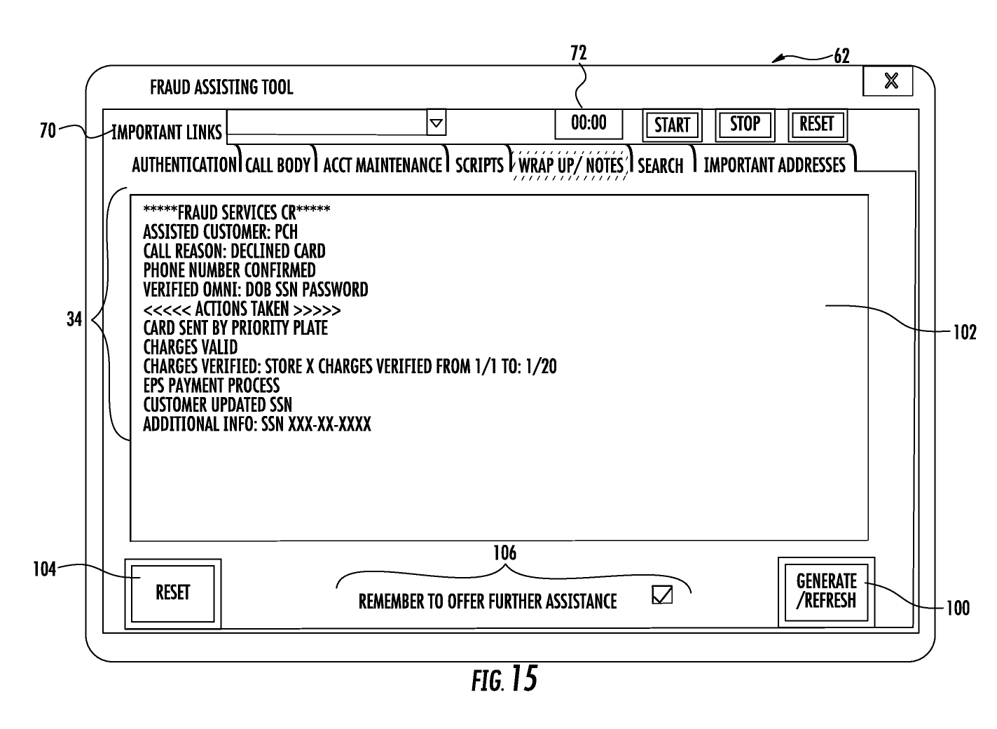

In still further specific embodiments of the invention the user-interfaces 20 include a documentation user-interface 62. Examples of a documentation user-interface 62 are shown in FIGS. 14-15, and discussed infra. The documentation user-interface 62 is configured to receive a user input 22 that generates the details/notes 34 and displays the details/notes 34 within a field/window provided in the documentation user-interface 62. As previous discussed, the details/notes 34 are compiled based on previous inputs that the user/financial institution representative has have made within the user-interfaces 20 of the fraud call documentation assistance tool 18. If subsequent additional user inputs are received or modified after the details/notes 34 have been generated, a user input may be received to update the details/notes. Generation of the details/notes 34 may coincide with automatically storing the details/notes 34 in a customer and/or account database and/or the displayed details/notes 34 may be copied and pasted to a database of interest.

Additionally, the user-interfaces 20 of fraud call documentation assistance tool 18 may include a search engine user-interface 64 that is configured to allow a user/financial institution representative to input search criteria 66 to locate and display services 68 and corresponding telephone numbers of the service which may, based on the type of call/reason for the call or questions occurring during the call, be beneficial to the caller or required for further follow-up.

Moreover, in further embodiments of the invention, one or more, and in some instances all, of the user-interfaces 20 may include a listing of selectable important links 70 that are customarily accessed by the user/financial institution representative during fraud-related calls. In such embodiments the important links 70 may be presented in the form of a drop down menu or the like. In other embodiments of the invention one or more, and in some embodiments all, of the user-interfaces 20 include a timer 72 that allows the users to gauge how long the current call is taking as a means of tracking user efficiency.

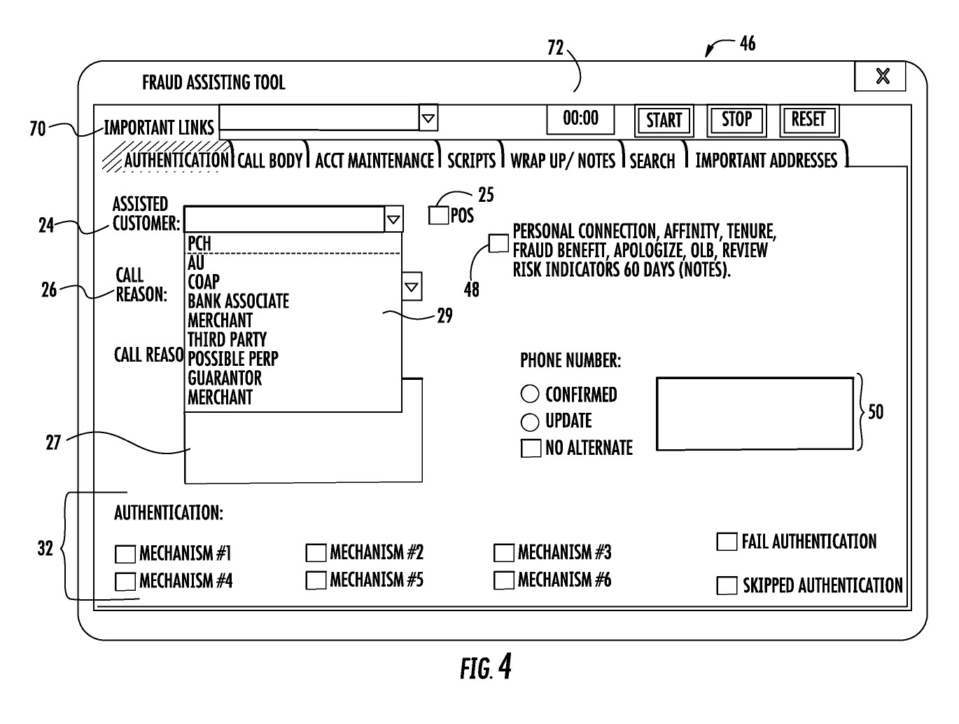

Referring to FIGS. 3-8, examples of an authentication user-interface 46 of a fraud call documentation assistance tool are shown, in accordance with embodiments of the present invention. The authentication user-interface is typically the user-interface displayed to the user/financial institution upon launching the tool and is typically the first user-interface completed by the user/financial institution representative in the automated documentation assistance process. The authentication user-interface 46 is configured to receive a user input that defines the type of caller 24. As shown in FIG. 4, the type of caller input field may comprise a drop-down menu 29 which lists the various types of callers (e.g., primary card holder (PCH), authorized user (AU), bank associate, merchant, third party, possible perpetrator or the like). A user/financial institution representative may select a type of caller from the drop down menu 29 and the selected type of caller is displayed in the “assisted customer” window. Additionally, a Point-of-Sale (POS) indicator 25 is included within the authentication user-interface, which is configured to be selected by the user/financial institution to indicate that the call is associated with a point-of-sale location (e.g., merchant or customer calling from a POS).

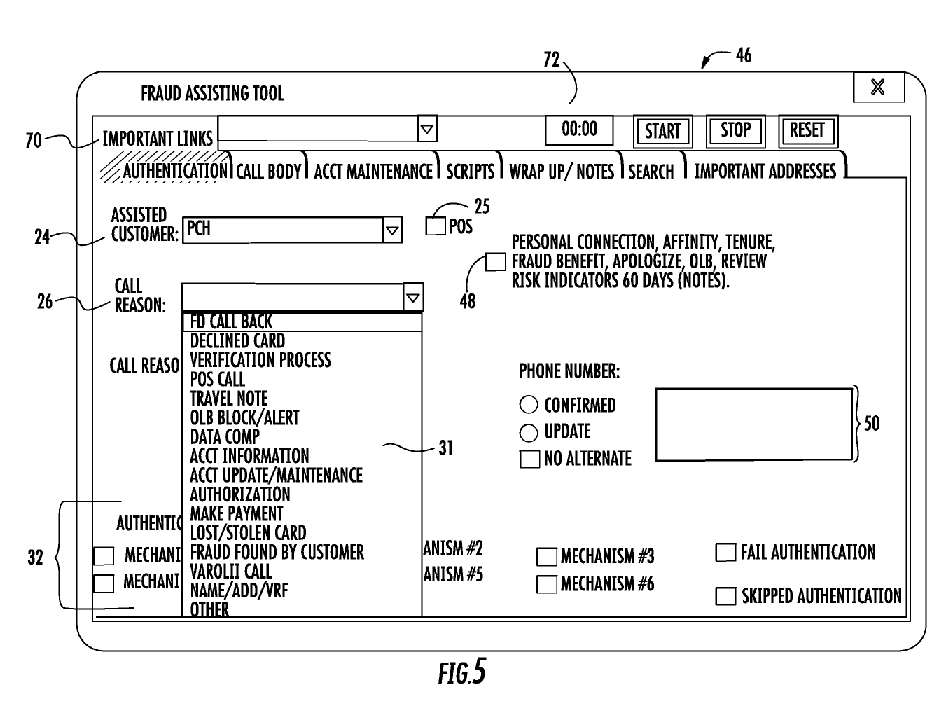

The authentication user-interface 46 is further configured to receive a user input that defines the call reason 26. As shown in FIG. 5, the call reason input field may comprise a drop-down menu 31 which lists the various call reasons (e.g., fraud call back, declined card, verification process, POS call, online banking block/alert, data compromised, account information or the like). A user/financial institution representative may select a call reason from the drop down menu 31 and the selected call reason is displayed in the “assisted customer” window. Additionally, call reason input field/window 27 is provided in the event the drop down menu does not list the call reason or if additional information is needed to supplement the call reason selected in the drop down menu 29.

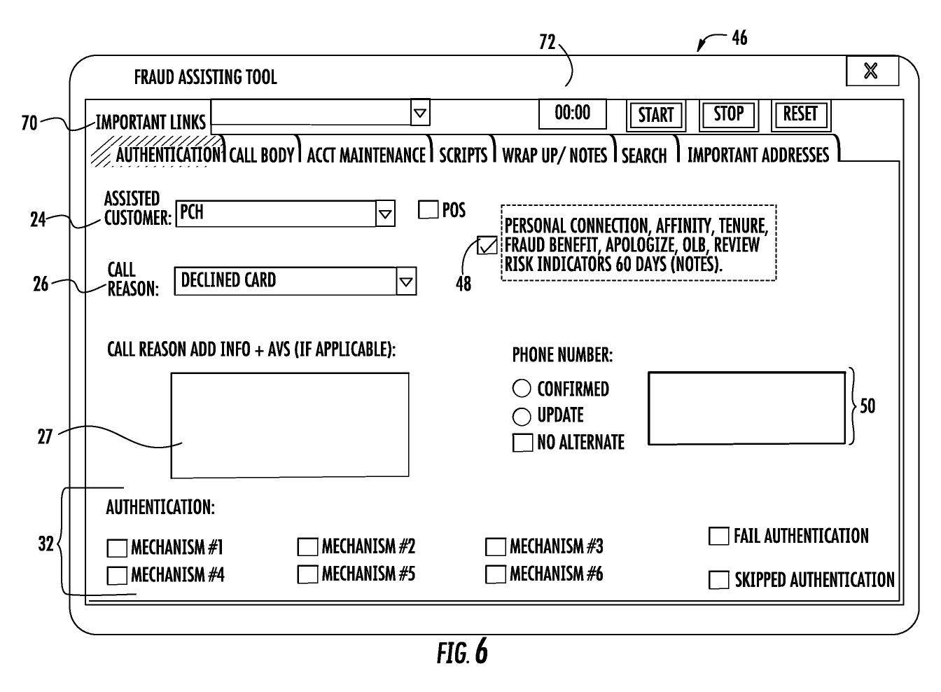

Additionally, the authentication user-interface 46 is configured to receive a user input that indicates/acknowledges that preliminary actions have been addressed on the call 48. As shown in the illustrated example, the preliminary actions include reviewing risk indicators, acknowledging the caller's tenure and affinities, apologizing for the inconvenience, personally greeting the customer and the like. As shown in FIG. 6, once the user/financial institution representation, has provided the request user input (selecting the radio indicator/acknowledgement 48), the user-interface responds by providing the user/financial institution representative access to further functionality within the authentication user-interface 46. Specifically, in the illustrated embodiment shown in FIG. 6, providing a user input that selects the radio indicator/acknowledgement 48, provides the user/financial institution representative access to the selection of an authentication mechanism 32 and the telephone confirmation/update 50 input fields.

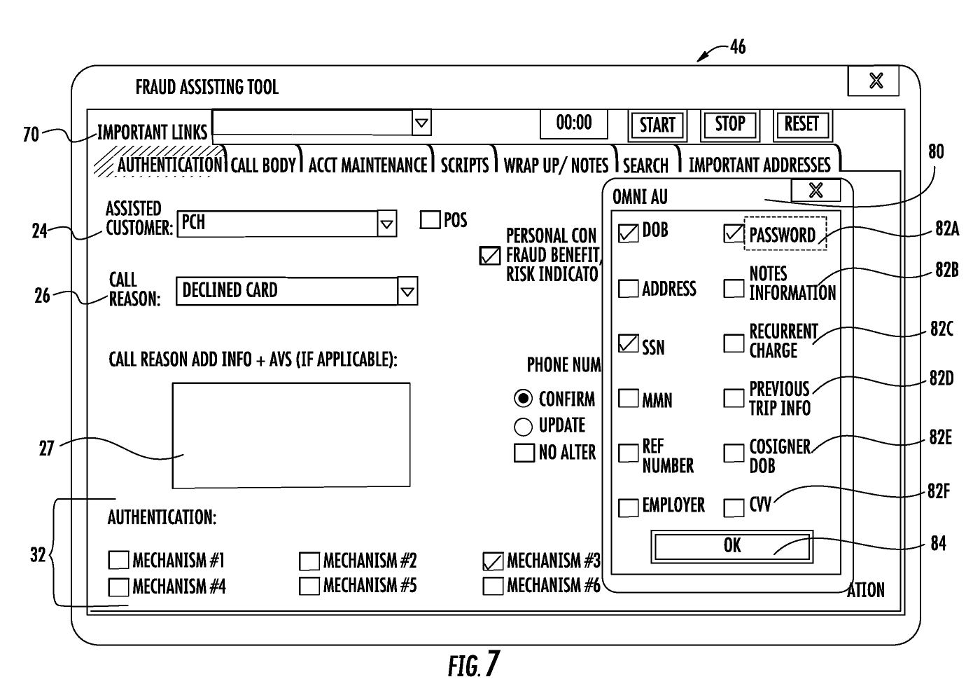

As shown in FIG. 7, once the user/financial institution representative has selected an authentication mechanism 32, a supplemental authentication criteria user-interface 80 may be displayed that includes a plurality of authentication criteria 82A-82F, which may be requested of the caller for the purpose of authenticating/verifying the identity of the caller. Examples of authentication criteria for the selected authentication mechanism (OMNI) include password 82A, notes information 82B, recurrent charge 82C, previous trip information 82D, Cosigner date of birth 82E and card verification value (CVV) and the like. Additionally, the authentication criteria user-interface 80 includes “OK” icon 84 configured to selected by the user to exit the authentication criteria user-interface 80. In addition, the authentication mechanisms 32 of authentication user-interface 46 include user input fields for indicating that the caller failed authentication or that authentication was omitted (i.e., skipped).

The telephone confirmation/update 50 input fields of authentication user-interface 46 are configured to allow the user to indicate that the callers telephone number has been confirmed, updated or that no alternate telephone number exists. Additional, telephone confirmation/update 50 input fields include a field/window for inputting the updated telephone number(s).

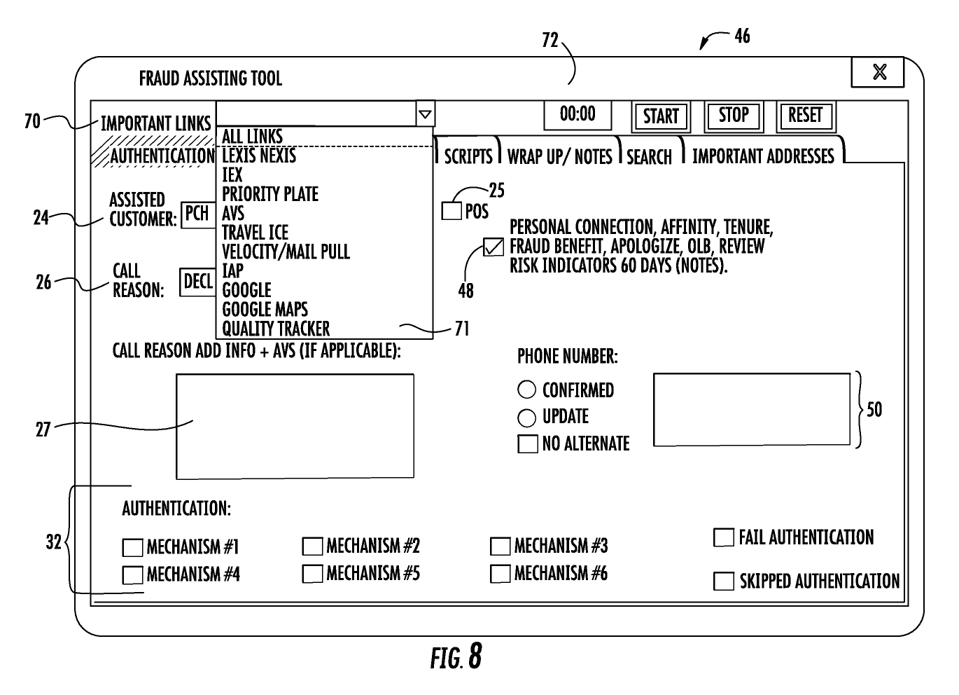

Additionally, the user-interfaces illustrated in FIGS. 3-17 all include an important links 70 feature and a timer 72. As shown in FIG. 8, the important links 70 feature may include a drop down menu 71 that includes a list of the important links 70. The important links are networked based Internet or intranet sites that are customarily relied upon by the user/financial institution representative when conducting a fraud call. A user/financial institution representative may select an important link from the drop down menu 31 and the user is provided access to the selected important link 70. The timer 72 feature serves to keep the user/financial institution representative cognizant of the time spent on the current call.

Referring to FIGS. 9-11, examples of a call body user-interface 52 of a fraud call documentation assistance tool are shown, in accordance with embodiments of the present invention. The call body user-interface 52 is configured to receive a user input that defines the type of call 30, or the disposition of the call. In the illustrated embodiment of FIG. 9 a drop down menu 90 is implemented in which the user chooses type of call from the list. The type of call 30 may include but is not limited to, charges valid, card not present (CNP), lost or stolen (L/S) card, counterfeit (CFT), never received card (NVC), authorization removal, fraud application (FRAAP) or the like. In response to the user providing a type of call 30 input, the call-type specific actions 28 to be taken by user/financial institution representative are displayed in the call body user-interface 52 along with a corresponding radio indicator for the user to “check-off” once the corresponding action has been taken by the user.

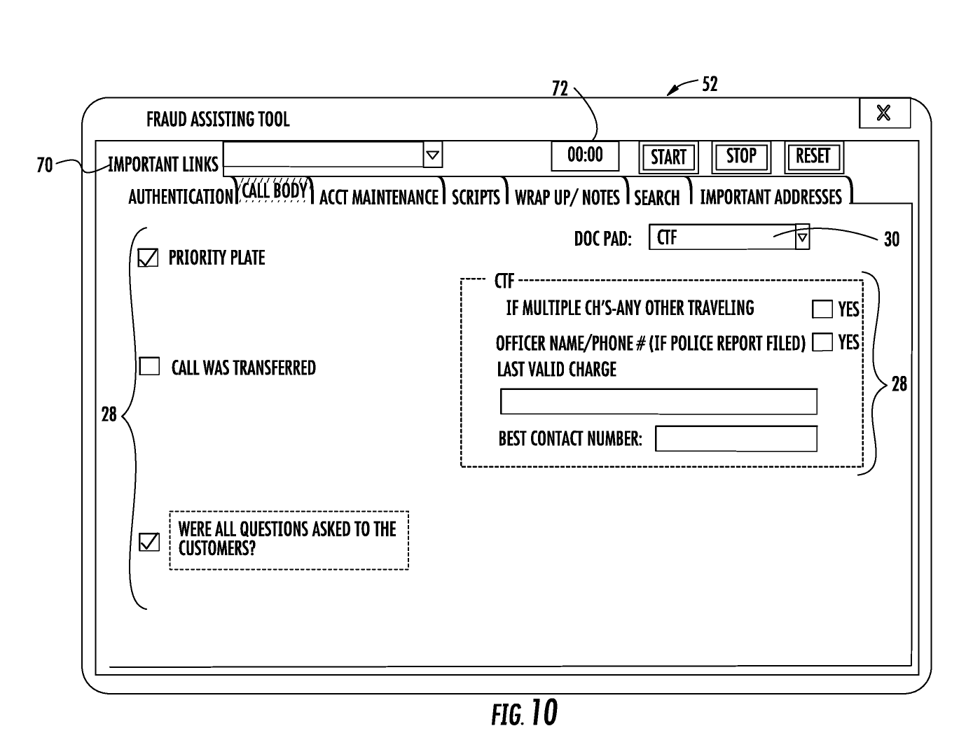

For example, referring to FIG. 10, the user/financial institution representative has chosen counterfeit as the type of call 30. The user has indicated that a new credit/debit has been requested and will be sent prioritized (“priority plate”). Once the user/financial institution representative has indicated, by checking the corresponding radio box, that all questions have been asked to the caller/customer, the specific action 38 box on the right-hand of the call body user-interface 52 becomes available to user (i.e., is unblocked) for inputting answers to the required counterfeit-related queries. Specifically, the user is required to determine, if the account has multiple card holders (CH's), whether any other of the card holders are currently travelling and, if a police report has been filed, the office name and phone number. In addition, the user/financial institution representative, who has access to the card account, is required to indicate the last valid charge (i.e., the last charge that the caller indicates was conducted by the caller or an authorized party) and a best contact number for contacting the caller for future questions concerning the matter.

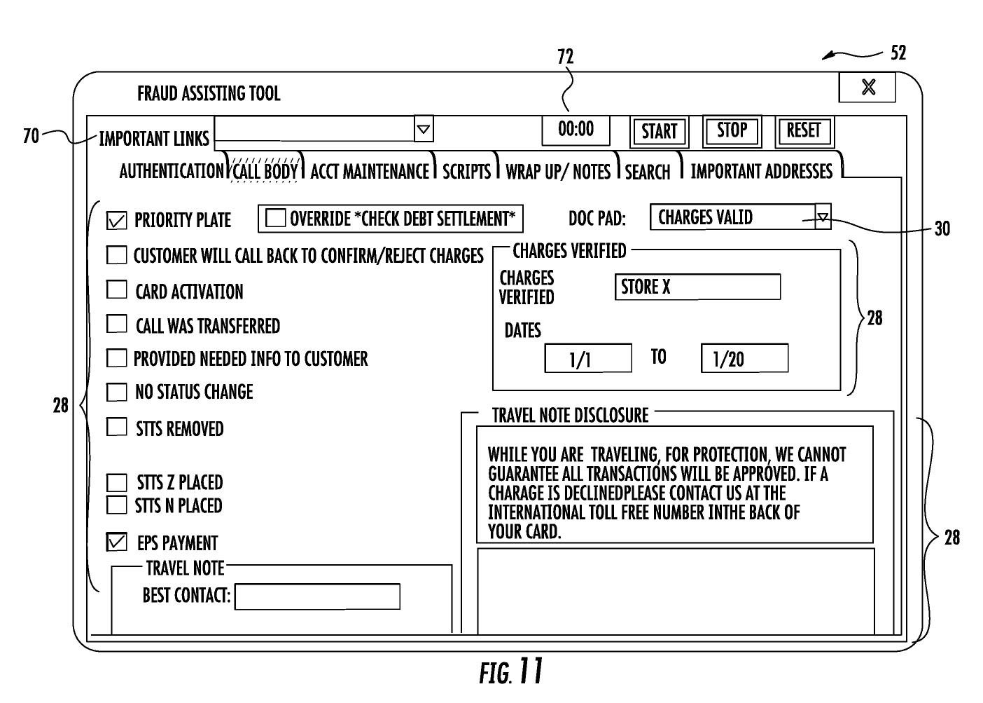

In another example, referring to FIG. 11, the user/financial institution representative has chosen charges valid (based on the caller travelling outside of normal zone for using the credit/debit card) as the type of call 30. The user is required to indicate the actions 28 associated with the charges being valid by “checking-off” the appropriate radio boxes. In addition, the user/financial institution representative, may input a best contact number to use while the caller is travelling, the name of the merchant at which the charges have been verified and the date range for the charges that have been verified. In addition the call-type specific actions 28 include a travel note disclosure which is required to be communicated to the caller during the call.

Referring to FIG. 12 an example of an account maintenance user-interface 54 of a fraud call documentation assistance tool is shown, in accordance with embodiments of the present invention. The account maintenance user-interface 52 is configured to receive user inputs that indicate that the callers account needs to be updated based on information provided by the caller during the call. In the illustrated embodiment of FIG. 12, the account maintenance user-interface 52 provides for indicating (by “checking off” the corresponding radio box) that one or more of following requires updating (a) cancellation of the fraud claim; (b) change in employer; (c) change in email address; (d) change in home address; (e) correction to date-of-birth; (f) add or correction to mother's maiden name; (g) correction or change in first and/or last name; (h) add or correction to social security number; (h) change in password; and (i) add or remove authenticated user to or from account. In addition, account maintenance user-interface 52 provides for an input field/window 57 to allow the user/financial institution representative to input account maintenance information, such as updates/changes to data and the like. In addition, in response to the user indicating a need to change profile data 56, information may be displayed to the user that pertains to that particular account maintenance item. In the illustrated embodiment of FIG. 12, the user/financial institution representative has indicated that the social security number (SSN) requires updating/correction and has provided the updated social security number in the input field/window 57. In addition, information is provided in the account maintenance user-interface 52 that needs to be communicated to the caller during the caller—e.g., possible need provide documentation of the social security number and advising as to the length of time required for the change to show on the account.

Referring to FIG. 13 an example of a script user-interface 54 of a fraud call documentation assistance tool is shown, in accordance with embodiments of the present invention. The account maintenance user-interface 52 is configured to receive user inputs that indicate the type of call 30 e.g., fraud charges, fraud save, data compromised, and lost/stolen card. In addition, the user/financial institution representative may indicate the language spoken by the caller so that scripts are provided in the language relevant to the call. In response to receiving the user/financial institution representative indication of the type of call, scripts 59 are displayed in the script user-interface 54 that are required to be communicated to the caller during the call. In addition, script user-interface 54 provides for the user/financial institution representative to input an acknowledgement 60 that the scripts have been communicated to the caller.

Turning the reader's attention to FIGS. 14-15, examples of documentation (e.g., “wrap up/notes”) user-interface 62 of a fraud call documentation assistance tool is shown, in accordance with embodiments of the present invention. The documentation user-interface 62 includes a generate/refresh key 100 that is configured to receive a user input that generates details/notes pertaining to the current call. The generated details/notes are based on previous user/financial institution representative inputs provided in the authentication user-interface 46, call body user-interface 52, account maintenance user-interface 54 and/or script user-interface 58. In response to receiving the user input to generate the details/notes. The details/notes 34 are displayed in window/input field 102, as shown in FIG. 15. Once displayed, the user/financial institution representative can edit, delete or add to the displayed details/notes, as applicable. In addition, documentation user-interface 52 includes a reset key 104 that is configured to receive a user input that resets the details/notes. Resetting of the details/notes deletes all previous user inputs made within the fraud call documentation assistance tool 18 and, as such, deletes the details/notes from the window input field 102 and requires that the user provide new entries in the authentication user-interface 46, call body user-interface 52, account maintenance user-interface 54 and/or script user-interface 58. Generation of the details/notes may be configured to store the details/notes in a user/account database or the user/financial institution representative may manually cut and paste the details/notes to a desired storage location. In addition, documentation user-interface 62 includes acknowledgement indication 106 that is configured to receive a user input (by “clicking-on” the corresponding radio box) that indicates that the user has offered the caller further assistance.

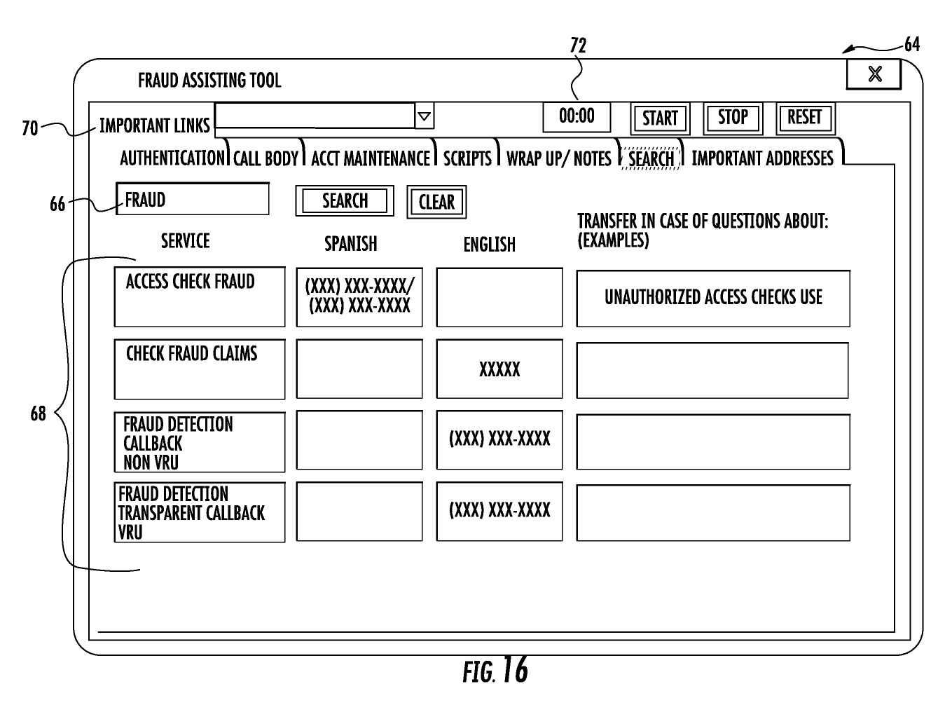

Referring to FIG. 16, an example of a search engine user-interface 64 of a fraud call documentation assistance tool is shown, in accordance with embodiments of the present invention. The search engine user-interface 64 includes a search criteria 66 input field for receiving a user input that defines the search criteria. In response to providing the search criteria and receiving a user input that selects the search key, search results 68 are displayed in the form of name(s) of services and corresponding telephone numbers (both English and Spanish language telephone numbers) and an indication of the relevancy of the services. The service(s) and corresponding telephones displayed as a result of the search may be provided to the caller in the event the caller asks questions that the user/financial institution representative is unable to answer or the caller may be transferred during the call to the service by the user/financial institution representative.

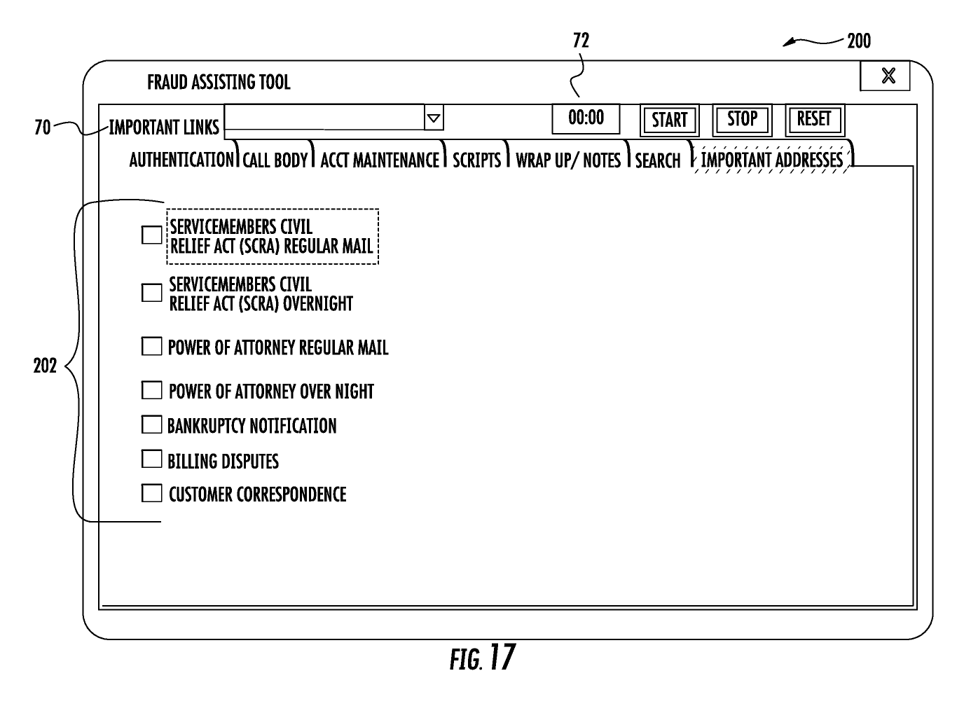

Moreover, FIG. 17 provides an example of an important addresses user-interface 200 of a fraud call documentation assistance tool is shown, in accordance with embodiments of the present invention. The important addresses user-interface 200 is configured to receive a user input that selects an entity (by “clicking on” the radio box of the corresponding entity). In response to selecting the entity the corresponding contact information (e.g., mailing address, telephone number or the like) is displayed to the user/financial institution representative.

Thus, systems, apparatus, methods, and computer program products described above provide for automating and standardizing documentation of details (e.g., notes or the like) associated with fraud-related financial institution customer calls. Automating the documentation of call details results in a highly efficient process that eliminates the need for the financial institution representatives to manually input notes during or after a call, thereby decreasing the overall time needed to conduct a call. Standardization of the documentation of details/notes, assures that the notes are accurate and are in a format that can be readily interpreted and used by subsequent financial institution representatives engaged in future calls from the customer or other activities requiring call history information.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible.

Those skilled in the art may appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. An apparatus for automated documentation of details associated with a card fraud-related financial institution customer call, the apparatus comprising:
a computing platform including a memory and a processor in communication with the memory;
a fraud call documentation assistance tool stored in the memory, executable by the processor and configured to,
display a plurality of user-interfaces that are configured to receive a plurality of user inputs during a financial institution call that has been determined to be card fraud-related and, as result of the user inputs, generate, display and store, in a standardized format, details associated with the financial institution call, wherein the user inputs and the details include (1) type of caller, (2) reason for call, (3) authentication mechanism and criteria (4) type of call, and (5) actions taken during call.

2. The apparatus of claim 1, wherein the fraud call documentation assistance tool is further configured to display the plurality of user-interfaces including an authentication user-interface configured to receive user inputs including (1) the type of caller, (2) the call reason and (3) an indication that a plurality of preliminary actions have been addressed on the call.

3. The apparatus of claim 2, wherein the fraud call documentation assistance tool is further configured to display the authentication user-interface configured to, in response to receiving the user input that indicates that the plurality of preliminary actions have been addressed on the call, display user input fields configured to receive (1) a telephone number confirmation or update and (2) the authentication mechanism and (3) the authentication criteria.

4. The apparatus of claim 1, wherein the fraud call documentation assistance tool is further configured to display the plurality of user-interfaces including a call body user-interface configured to receive the user input for the type of call and, in response to receiving the user input for the type of call, display a listing of call type-specific actions that are preferred to be taken during the call, wherein each of the actions has a corresponding user input field configured to receive a user indication that the action has been performed.

5. The apparatus of claim 1, wherein the fraud call documentation assistance tool is further configured to display the plurality of user-interfaces including an account maintenance user-interface configured to receive one or more user inputs that indicate an update to personal profile information associated with the calling customer or an account associated with the calling customer.

6. The apparatus of claim 1, wherein the fraud call documentation assistance tool is further configured to display the plurality of user-interfaces including a script user-interface configured to receive a user input that indicates a type of fraud and, in response to receiving the user input that indicated a type of fraud, display a plurality of scripts associated with the type of fraud that are to communicated to the calling customer.

7. The apparatus of claim 6, wherein the fraud call documentation assistance tool is further configured to display the plurality of user-interfaces including the script user-interface configured to receive a user input that acknowledges communication of the scripts to the calling customer, wherein receipt of the user input that acknowledges communication of the scripts provides the user access to a documentation user-interface

8. The apparatus of claim 1, wherein the fraud call documentation assistance tool is further configured to display the plurality of user-interfaces including a documentation user-interface configured to receive a user input that generates, in a standardized format, documentation for the call based on previous user inputs.

9. The apparatus of claim 1, wherein the fraud call documentation assistance tool is further configured to display the plurality of user-interfaces including a search engine user-interface that is configured to receive user inputs that define search criteria and, as a result of performing a search, display one or more of a service names responsive to the search criteria, and a telephone number associated with the service name.

10. The apparatus of claim 1, wherein the fraud call documentation assistance tool is further configured to display the plurality of user-interfaces, wherein each user-interface includes (1) a selectable menu of important network links accessible to the user during the call and (2) a timer for timing a length of the call.

11. A computer program product comprising:
a non-transitory computer-readable medium comprising:
a set of codes for causing a computer to display a plurality of user-interfaces that are configured to receive a plurality of user inputs during a financial institution call that has been determined to be card fraud-related and, as result of the user inputs, generate, display and store, in a standardized format, details associated with the financial institution call, wherein the user inputs and the details include (1) type of caller, (2) reason for call, (3) authentication mechanism and criteria (4) type of call, and (5) actions taken during call.

12. The computer program product of claim 11, wherein the set of codes is further configured to cause the computer to display the plurality of user-interfaces including an authentication user-interface configured to receive user inputs including (1) the type of caller, (2) the call reason and (3) an indication that a plurality of preliminary actions have been addressed on the call.

13. The computer program product of claim 12, wherein the set of codes is further configured to cause the computer to display the authentication user-interface configured to, in response to receiving the user input that indicates that the plurality of preliminary actions have been addressed on call, display user input fields configured to receive (1) a telephone number confirmation or update and (2) the authentication mechanism and (3) the authentication criteria.

14. The computer program product of claim 11, wherein the set of codes is further configured to cause the computer to display the plurality of user-interfaces including a call body user-interface configured to receive the user input for the type of call and, in response to receiving the user input for the type of call, display a listing of call type-specific actions that are preferred to be taken during the call, wherein each of the actions has a corresponding user input field configured to receive a user indication that the action has been performed.

15. The computer program product of claim 11, wherein the set of codes is further configured to cause the computer to display the plurality of user-interfaces including an account maintenance user-interface configured to receive one or more user inputs that indicate an update to personal profile information associated with the calling customer or an account associated with the calling customer.

16. The computer program product of claim 11, wherein the set of codes is further configured to cause the computer to display the plurality of user-interfaces including a script user-interface configured to receive a user input that indicates a type of fraud and, in response to receiving the user input that indicated a type of fraud, display a plurality of scripts associated with the type of fraud that are to communicated to the calling customer.

17. The computer program product of claim 16, wherein the set of codes is further configured to cause the computer to display the plurality of user-interfaces including the script user-interface configured to receive a user input that acknowledges communication of the scripts to the calling customer, wherein receipt of the user input that acknowledges communication of the scripts provides the user access to a documentation user-interface.

18. The computer program product of claim 16, wherein the set of codes is further configured to cause the computer to display the plurality of user-interfaces including a documentation user-interface configured to receive a user input that generates, in a standardized format, documentation for the call based on previous user inputs.

19. The computer program product of claim 11, wherein the set of codes is further configured to cause the computer to display the plurality of user-interfaces including a search engine user-interface that is configured to receive user inputs that define search criteria and, as a result of performing a search, display one or more of a service names responsive to the search criteria, and a telephone number associated with the service name.

20. The computer program product of claim 11, wherein the set of codes is further configured to cause the computer to display the plurality of user-interfaces, wherein each user-interface includes (1) a selectable menu of important network links accessible to the user during the call and (2) a timer for timing a length of the call.
